(19) United States
(12) Patent Application Publication
(10) Pub. No.: US 2021/0220911 A1
(43) Pub. Date: Jul. 22, 2021

(54) AN APPARATUS AND A METHOD FOR PRODUCING NANAOPARTICLES AND NANOCOMPOSITES BY CONTROLLED ELECTRO-EXPLOSION OF A METAL WIRE

(71) Applicant: Sangeeta Lal, NEW DELHI (IN)

(72) Inventor: Sangeeta Lal, NEW DELHI (IN)

(21) Appl. No.: 17/057,146

(22) PCT Filed: May 9, 2019
(86) PCT No.: PCT/IN2019/050368

§ 371 Date: Nov. 20, 2020

(30) Foreign Application Priority Data
May 23, 2018 (IN) 201811019283

(51) Int. Cl. B22F 9/14; C22C 1/05; B22F 1/00

(52) U.S. Cl. CPC B22F 9/14; B22F 1/0018; C22C 1/055

(57) ABSTRACT

The present invention relates to an apparatus for production of nanoparticles or nanocomposites. The apparatus comprises a metal wire (112) operably connected to a motor (124). The metal wire (112) passes through a first wire guide (114). There are at least two rollers (118, 120), with at least one roller amongst said at least two rollers (118, 120) being metallic. At least one roller amongst said at least two rollers (118, 120) is connected to said motor (124). Said at least two rollers (118, 120) being in contact and rolling at a predetermined speed (X). Said metal wire (112) after passing through said first wire guide (114) passes between said at least two rollers (118, 120). Said at least two rollers (118, 120) guiding said metal wire (112) through a second wire guide (122) onto said plate (140), said second wire guide (122) being an insulator. Said plate (140) being placed inside a medium (138). A container (136) enclosing said plate (140) and said medium (138). A power supply (142), wherein a first terminal (144) of said power supply (142) is electrically in contact with said metal wire (112) and a second terminal (146) of said power supply (142) is electrically in contact with said plate (140). A contact sensing unit (154) operably connected to said at least two rollers (118, 120), said metal wire (112), said plate (140), said motor (124) and said power supply (142), said motor (124) intermittently rolling at least one roller amongst said at least two rollers (118, 120) rolling at said predetermined speed (X) bringing said metal wire (112) in contact with said plate (140). Intermittent controlled electro-explosions take place at a predetermined interval (T) as said metal wire (112) comes in contact with said plate (140).

### FIELD OF THE INVENTION

The present invention in general relates to an apparatus and a method for production of high purity nanoparticles and nanocomposites using electro-explosion, and in particular relates to an apparatus and a method for production of metal-metal and metal-graphene nanocomposites by controlled electro-explosion of a metal wire on a metal plate or a graphite plate.

### BACKGROUND OF THE INVENTION

Metal nanoparticles, metal-graphene and metal-metal nanocomposites have been a source of great interest due to their novel electrical, optical, physical, chemical, magnetic etc. properties. They have a wide range of applications including in catalysis, magnetic recording media, optoelectronic materials, magnetic fluids, composite materials, fuel cells, sensors, conducting polymers, EMI shielding, water purification, medical science etc. Their uniqueness arises from their high ratio of surface area to volume (aspect ratio).

The primarily used methods for preparing metal graphene nanocomposites are: micromechanical peeling, chemical vapour deposition (CVD), SIC epitaxy and oxidation-reduction chemical methods. Micromechanical peeling method has disadvantages, such as, poor controllability and limited production capacity. Accordingly, large scale production using this method is not desirable. CVD method gives a certain degree of graphene structure control, but the method involves high production costs, high level of process complexity and the quality of the graphene is also not high. SiC epitaxial method can be used for mass production but it is difficult to control the formation of layers of impurities over the nanocomposites and the related costs are high. Synthesis through Inductive Plasma Coupling has limitation on the size of the nanocomposites and this process is very expensive.

Alternative chemical production methods, such as thermal decomposition and precipitation, chemical reduction of graphene oxide and metal compounds are currently being used for the preparation of a wide range of nanocornposites. Though the chemical methods can provide large quantities of nanocomposites, they are cost prohibitive, not eco-friendly and do not produce high purity, surfactant free nanocomposites. Moreover, the commonly used reducing agents, such as, hydrazine hydrate have a certain degree of toxicity. Another method to make large quantities of graphene for nanocomposites is to exfoliate graphite into individual graphene sheets by using chemicals and then use it for making nanocornposites. The downside of this approach is the presence of oxygen functional groups in graphene that are difficult to remove. The resultant material is highly disordered with electronic properties inferior to the material produced by techniques like chemical vapour deposition. Graphene oxide is electrically non-conducting, which makes it less useful for products. Oxygen distorts the pristine atomic structure of graphene and degrades its properties.

Similarly, metal-metal nanocomposites are primarily prepared by some of the above mentioned methods like Chemical methods, which include thermal decomposition and precipitation, CND, inductive plasma coupling, ball milling etc. Disadvantages of using these methods are discussed in the preceding paragraph.

In some of the literature where nanoparticles and nanocomposites are made through a different electro-explosion method where capacitor is used as a power supply, a thicker wire is used for explosion and the explosion is done generally in air and sometimes in liquid medium. For making metal-metal nanocomposites, two wires of different metals are twisted together and exploded in air or a single wire is exploded in a medium which contains nanoparticles of another metal or nano-sheets of graphene to make a metal-metal or metal-graphene nanocomposites. Drawback of this type of electroexplosion method is that the resulting distribution in the size of nanocomposites is large.

Electrical explosion of wires (EEW) is a process of explosive destruction of a metal wire under the action of great density current (>10⁶ A/cm2). EEW is characterized by some peculiarities like, time of explosion is 10−5 . . . 10−8 s; temperature at the moment of explosion can reach the value more than 10⁴ K, velocity of product recession is from 1 to 5 km/s. Material of the wire transmutes into particles of nanosized range, for instance 2 -100 nm, in accordance with certain conditions of experiments. Extremely non-equilibrium conditions of EEW cause some unusual properties of nano-powders.

Surface condition of the nanopartides, inter-particle electrostatic interaction and thermodynamic stability of the medium determine the final particle morphology. EEW in chemically active ambient is used to produce nanopowders of chemical compounds of metals: oxides, nitrides, carbides, sulphides etc. The metal carbides such as Al₄C₃, LaC₂, TiC, ZrC, NbC, Nb₂C, Ta₂C, MoC, and W₂C were synthesized by electrical explosions of corresponding wires in ethane, isobutene, acetylene, and butanol etc.

The size and morphology of the synthesized particles are strongly affected by experimental conditions such as input power, current density, medium temperature, pH of the medium and wire diameter. Diameter of the particles decreases with decreasing of the metal wire diameter at fixed voltage and also with the rise in temperature of the medium in which explosion takes place.

It is desirable to eliminate the disadvantages of usually prevalent electro-explosion of wire technique where capacitor is used as a power source and a fixed length of considerably long and thick wire is exploded in a closed chamber, resulting in the production of nanoparticle size ranging from 2-200 nms. Accordingly, there is a need to obviate the disadvantages of the pre-existing techniques, and develop an apparatus and a process which is not complex, results in higher purity levels, results in smaller particle size with a lower distribution in size, has high yield, is economical, and can be used for large scale production.

### OBJECTS OF THE INVENTION

One of the object of this invention is to develop a simple, cheap and cost effective process to synthesize metal-graphene and metal-metal nanocomposites by electro explosion.

Still another object of the present invention is to use low voltages between 25V-50V DC, while also having the possibility of employing AC voltages for the purpose, thereby reducing the energy costs involved in production of nanoparticles and nanocomposites.

Still another object of the present invention is to provide for the use of various dense liquids as medium of explosion, irrespective of their dielectric property.

Still another object of the present invention is to provide a method by which capping is achieved on the nanomaterials with a suitable layer of an inert or active material already present in the medium or is produced around the nanomaterial due to a reactive step in the environment of the medium present.

Yet another object of the present invention is an enhancement in the properties of metal nanoparticles through inclusion of graphene or other metals. In metal graphene nanocomposites, metal nanoparticles are dispersed on the surface of the graphene sheet, which can overcome the inter-layer graphene great van der Waals forces which prevent agglomeration between the graphene.

### SUMMARY OF THE INVENTION

The present invention relates to an apparatus for production of nanoparticles or nanocomposites. The apparatus comprises a metal wire operably connected to a motor. The metal wire passes through a first wire guide. The apparatus also comprises at least two rollers, at least one roller amongst the at least two rollers being metallic. At least one roller amongst the at least two rollers is connected to the motor. The at least two rollers are in contact and are rolling at a predetermined speed. The metal wire after passing through the first wire guide passes between the at least two rollers. The at least two rollers guide the metal wire through a second wire guide onto the plate. The second wire guide is an insulator. The plate is placed inside a medium. A container encloses the plate and the medium. A first terminal of a power supply is electrically in contact with the metal wire and a second terminal of the power supply is electrically in contact with the plate. A contact sensing unit is operably connected to the at least two rollers, the metal wire, the plate, the motor and the power supply. The motor is intermittently rolling at least one roller amongst the at least two rollers rolling at the predetermined speed bringing the metal wire in contact with the plate.

Intermittent controlled electro-explosions take place at a predetermined interval as the metal wire comes in contact with the plate. In an embodiment of the invention, the apparatus the at least two rollers are a first roller and a second roller. In another embodiment of the invention, the contact sensing unit turns OFF the motor as a contact resistance between the metal wire and the plate reaches between 0 to 20 ohms. The contact sensing unit turns ON the power supply after the motor is turned OFF resulting in an electro-explosion. The contact sensing unit turns OFF the power supply and turns ON the motor after the electro-explosion has occurred. In another embodiment of the invention, the plate is made up of a metal or graphite. In another embodiment of the invention, the predetermined, speed of the first roller and the second roller is such that it feeds 0.5-3 cms metal wire per minute. In another embodiment of the invention, the predetermined interval is at least 1 second. In yet another embodiment of the invention, the first terminal of the power supply is a negative terminal and the second terminal of the power supply is a positive terminal. In yet another embodiment of the invention, the second wire guide is made of glass. In yet another embodiment of the invention, a voltage in a range of 25V to 50V and current in a range of 40 Amp to 50 Amp is applied between the first terminal and the second terminal. In yet another embodiment of the invention, the medium is selected from amongst double distilled water, organic solvents like ethane, isobutene, acetylene, butanol etc. and heavy oils.

The present invention also relates to a method for production of nanoparticles or nanocomposites. The method comprises various steps such as operably connecting a motor to a metal wire; passing the metal wire through a first wire guide; connecting at least one roller amongst at least two rollers to the motor, at least one roller amongst the at least two rollers being metallic, the at least two rollers being in contact and rolling at a predetermined speed, the metal wire after passing through the first wire guide passing between the at least two rollers; the at least two rollers guiding the metal wire through a second wire guide onto a plate, the second wire guide being an insulator; placing the plate inside a medium; enclosing the plate and the medium in a container; electrically connecting a first terminal of a power supply to the metal wire and a second terminal of the power supply to the plate; operably connecting a contact sensing unit to at least one roller among the at least two rollers, the metal wire, the plate, the motor and the power supply, the motor intermittently rolling at least one roller amongst the at least two rollers at the predetermined speed bringing the metal wire in contact with the plate, wherein intermittent controlled electro-explosions take place at a predetermined interval (T) as the metal wire comes in contact with the plate. In an embodiment of the invention, the at least two rollers are a first roller and a second roller. In another embodiment of the invention, the contact sensing unit turns OFF the motor as a contact resistance between the metal wire and the plate reaches between 0 to 20 ohms. The contact sensing unit turns ON the power supply after the motor is turned OFF resulting in an electro-explosion. The contact sensing unit turns OFF the power supply and turns ON the motor after the electro-explosion has occurred. In another embodiment of the invention, the plate is made up of a metal or graphite. In another embodiment of the invention, the predetermined speed of the first roller and the second roller is such that it feeds 0.5-3 cms metal wire per minute. In another embodiment of the invention, the predetermined interval is at least 1 second. In yet another embodiment of the invention, the first terminal of the power supply is a negative terminal and the second terminal of the power supply is a positive terminal. In yet another embodiment of the invention, the second wire guide is made of glass. In yet another embodiment of the invention, a voltage is applied in a range of 25V to 50V and current is applied in a range of 40 Amp to 50 Amp between the first terminal and the second terminal. In yet another embodiment of the invention, the medium is selected from amongst double distilled water, organic solvents like ethane, isobutene, acetylene, butanol etc. and heavy oils.

### BRIEF DESCRIPTION OF THE DRAWING

The object of the invention may be understood in more detail and more particularly with reference to the description of the invention briefly summarized by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 illustrates an isometric view of an embodiment of the apparatus for production of nanoparticles and nanocomposites by controlled electro-explosion of a metal wire as disclosed herein.

FIG. 2 illustrates an enlarged isometric view of the area denominated by ‘A’ in FIG. 1 of an embodiment of the apparatus for production of nanoparticles and nanocomposites by controlled electro-explosion of a metal wire as disclosed herein.

FIG. 3 illustrates an embodiment of the contact sensing circuit of the apparatus for production of nanoparticles and nanocomposites by controlled electro-explosion of a metal wire as disclosed herein.

FIG. 4 illustrates a front view of an embodiment of the apparatus for production of nanoparticles and nanocomposites by controlled electro-explosion of a metal wire as disclosed herein, wherein X>>Y, that is, when there is a gap between the metal wire and the plate and the contact is riot sufficient for electro-explosion to take place.

FIG. 5 illustrates another isometric view of an embodiment of the apparatus for production of nanoparticles and nanocomposites by controlled electro-explosion of a metal wire as disclosed herein, wherein X>Y, that is, when the metal wire and the plate are in contact but the contact is not sufficient for electro-explosion to take place.

FIG. 6 illustrates another isometric view of an embodiment of the apparatus for production of nanoparticles and nanocomposites by controlled electro-explosion of a metal wire as disclosed herein, wherein X<Y, that is, when the metal wire and the plate are in contact and sufficient contact has been established and the electro -explosion takes place.

FIG. 7 illustrates flow chart of the method used for the production of nanoparticles and nanocomposites.

FIG. 8A-8F illustrates the characterization results of Copper nanoparticles and copper graphene nanocomposites, whereas 8A and 8B are the TEM images of Cu Nanoparticles and Cu Graphene nanocomposite. 8C, 8D and 8E are the absorption spectra in the uV visible range and 8F is the comparative XRD plot of copper nanoparticles and copper graphene nanocomposite.

FIG. 9A-9F illustrate the characterization results of silver nanoparticles and silver graphene nanocomposites, whereas 9A and 9B are the the TEM images of Ag Nanoparticles and Ag Graphene, 9C and 9D are their absorption spectras in the uV visible range and 9E and 9F are the comparative XRD plot of silver nanoparticles and silver graphene nanocomposite.

FIG. 10A-10E illustrate the characterization results of iron nanoparticles and iron graphene nanocomposites, whereas 10A is the the TEM images of Fe Nanoparticles and and 10B and 10C are the TEM images of Fe Graphene, 10E is the absorption spectra in the uV visible range and 10D is the comparative XRD plot of iron nanoparticles and iron grapheme nanocomposite.

FIG. 11A-11D illustrates the characterization results of gold nanoparticles and gold graphene nanocomposites, whereas 11A is the TEM images of Au Nanoparticles and 11B and 11C are two different TEM images of Au (graphene, 11D is the absorption spectra in the uV visible range of gold nanoparticles and gold graphene nanocomposite.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

The present invention in general relates to an apparatus and a method for production of high purity nanoparticles and nanocomposites using electro-explosion, and more particularly relates to an apparatus and a method for production of metal-metal and metal-graphene nanocomposites by controlled electro -explosion of a metal wire on a metal plate or a graphite plate.

The preferred embodiment of the present invention relates to apparatus for production of nanoparticles or nanocomposites. The apparatus comprises a metal wire operably connected to a motor. The metal wire passes through a first wire guide. The apparatus also comprises at least two rollers, at least one roller amongst the at least two rollers being metallic. At least one roller amongst the at least two rollers is connected to the motor. The at least two rollers are in contact and are rolling at a predetermined speed. The metal wire after passing through the first wire guide passes between the at least two rollers. The at least two rollers guide the metal wire through a second wire guide onto the plate. The second wire guide is an insulator. The plate is placed inside a medium. A container encloses the plate and the medium. A first terminal of a power supply is electrically in contact with the metal wire and a second terminal of the power supply is electrically in contact with the plate. A contact sensing unit is operably connected to the at least two rollers, the metal wire, the plate, the motor and the power supply. The motor is intermittently rolling at least one roller amongst the at least two rollers rolling at the predetermined, speed bringing the metal wire in contact with the plate. Intermittent controlled electro-explosions take place at a predetermined interval as the metal wire comes in contact with the plate. In an embodiment of the invention, the apparatus the at least two rollers are a first roller and a second roller. In another embodiment of the invention, the contact sensing unit turns OFF the motor as a contact resistance between the metal wire and the plate reaches between 0 to 20 ohms. The contact sensing unit turns ON the power supply after the motor is turned OFF resulting in an electro-explosion. The contact sensing unit turns OFF the power supply and turns ON the motor after the electro-explosion has occurred. In another embodiment of the invention, the plate is made up of a metal or graphite. In another embodiment of the invention, the predetermined speed of the first roller and the second roller is such that it feeds 0.5-3 cms metal wire per minute. In another embodiment of the invention, the predetermined interval is at least 1 second. In yet another embodiment of the invention, the first terminal of the power supply is a negative terminal and the second terminal of the power supply is a positive terminal. In yet another embodiment of the invention, the second wire guide is made of glass. In yet another embodiment of the invention, a voltage in a range of 25V to 50V and current in a range of 40 Amp to 50 Amp is applied. between the first terminal and the second terminal. In yet another embodiment of the invention, the medium is selected from amongst double distilled water, organic solvents like ethane, isobutene, acetylene, butanol etc. and heavy oils.

In another embodiment, the present invention relates to a method for production of nanoparticles or nanocomposites. The method comprises various steps such as operably connecting a motor to a metal wire; passing the metal wire through a first wire guide; connecting at least one roller amongst at least two rollers to the motor, at least one roller amongst the at least two rollers being metallic, the at least two rollers being in contact and rolling at a predetermined speed, the metal wire after passing through the first wire guide passing between the at least two rollers; the at least two rollers guiding the metal wire through a second wire guide onto a plate, the second wire guide being an insulator; placing the plate inside a medium; enclosing the plate and the medium in a container; electrically connecting a first terminal of a power supply to the metal wire and a second terminal of the power supply to the plate; operably connecting a contact sensing unit to at least one roller among the at least two rollers, the metal wire, the plate, the motor and the power supply, the motor intermittently rolling at least one roller amongst the at least two rollers at the predetermined speed bringing the metal wire in contact with the plate, wherein intermittent controlled electro-explosions take place at a predetermined interval (T) as the metal wire comes in contact with the plate. In an embodiment of the invention, the at least two rollers are a first roller and a second roller. In another embodiment of the invention, the contact sensing unit turns OFF the motor as a contact resistance between the metal wire and the plate reaches between 0 to 20 ohms. The contact sensing unit turns ON the power supply after the motor is turned OFF resulting in an electro-explosion. The contact sensing unit turns OFF the power supply and turns ON the motor after the electro-explosion has occurred. In another embodiment of the invention, the plate is made up of a metal or graphite. In another embodiment of the invention, the predetermined speed of the first roller and the second roller is such that it feeds 0.5-3 cms metal wire per minute. In another embodiment of the invention, the predetermined interval is at least 1 second. In yet another embodiment of the invention, the first terminal of the power supply is a negative terminal and the second terminal of the power supply is a positive terminal. In yet another embodiment of the invention, the second wire guide is made of glass. In yet another embodiment of the invention, a voltage is applied in a range of 25V to 50V and current is applied in a range of 40 Amp to 50 Amp between the first terminal and the second terminal. In yet another embodiment of the invention, the medium is selected from amongst double distilled water, organic solvents like ethane, isobutene, acetylene, butanol etc. and heavy oils.

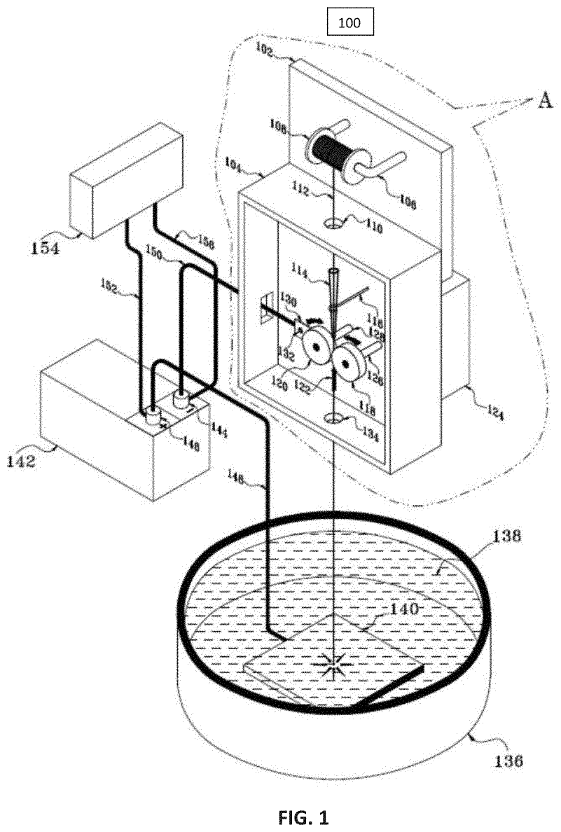

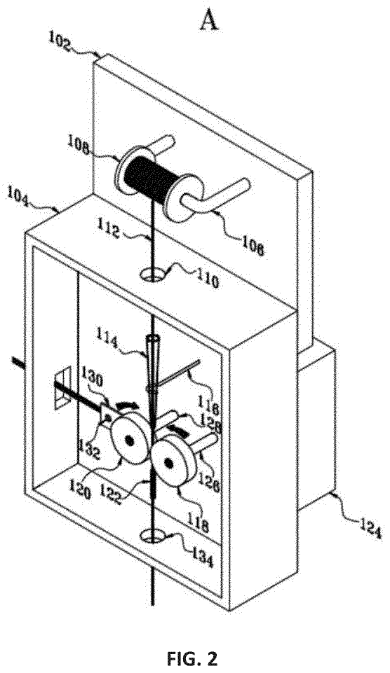

FIGS. 1 and 2 show an embodiment of the apparatus (100) for production of nanoparticles and nanocomposites by electro-explosion of a metal wire (112) on a plate (140). A base plate (102) has a box (104) mounted on one side. Above the box (104), a first clamp (106) has a wire spool (108) mounted on it. The box (104) has a first hole (110) on the upper side through which wire (112) that is wound on the wire spool (108) passes. After passing through the first hole (110) the metal wire (112) passes through a first wire guide (114) which is secured inside the box (104) with the help of a second clamp (116). The wire (112) thereafter passes between two rollers, namely, a first roller (118) and a second roller (120). After passing between the first roller (118) and the second roller (120), the metal wire (112) passes through a second wire guide (122). The first roller (118) is connected to a motor (124) through a first shaft (126). The second roller (120) is mounted on the box (104) by a second shaft (128) allowing the second roller (120) to rotate about the axis of the second shaft (128). A metal strip (130), on which the second roller (120) is mounted, is fixed inside the box (104) using a screw (132). The metal strip (130) is a good conductor of electricity through which current is supplied in the metal wire (112).

The first roller (118) in this embodiment is either a poor conductor of electricity or a metal, electrically insulated with the second roller, while the second roller (120) is a good conductor of electricity. In this embodiment, the second roller (120) is made of steel and the metal strip (130) is made of copper.

The motor (124) is placed on the other side of the base plate (102), which is made of acrylic fibre in this embodiment. The wire (112) after passing through the second wire guide (122) passes through a second hole (134). A container (136) containing a medium (138) is a closed container in this embodiment and allows the wire (112) to enter the container (136). A plate (140) is placed inside the medium (138) and is connected to a power supply (142). The plate (140) may be of any suitable material, such as, any metal or graphite etc. In this embodiment, the plate (140) is of graphite. In an alternate embodiment, metals like gold, silver, copper, aluminium, iron etc. may be used instead of graphite.

The power supply (142) has two terminals, namely, a first terminal, which is the negative terminal (144) and a second terminal, which is the positive terminal (146). A first electrical wire 150 connects the first terminal (144) with the metal strip (130), thereby connecting the second roller (120) with the power supply (142). A second electrical wire (148) connects the second terminal (146) with the plate (140). The second electrical wire (148) enters the container (136) from underneath and connects to the plate (140). A third electrical wire (152) connects the second terminal (146) with a contact sensing unit (154). A fourth electrical wire (156) connects the first terminal (144) with the contact sensing unit (154), In this embodiment, the first terminal (144) is a negative terminal and the second terminal (146) is a positive terminal.

The mechanism of the apparatus (100) is such that when the motor (124) is turned on, the first roller (118), which is attached to the shaft of the motor, starts rotating which is in close contact with the second roller (120). As a result the second roller (120) also starts rotating and the metal wire (112), which is placed in between the rollers, gets pulled and moves downwards towards the container (136). The wire (112) first comes in contact with the medium (138) and slowly reaches the plate (140). The speed (X) of the first roller (118) and the second roller (120) can be controlled and optimized by controlling the speed of motor (124), and the interval between successive electro explosions (T) is also controlled.

As the wire (112) comes in contact with the plate (140) and a good contact is established, the contact sensing unit (154) turns off the motor (124) and turns on the power supply (142). Because of short circuit at high current and voltage, an electro explosion takes place resulting in the formation of nanocomposites. Once the electro-explosion is over, length of the wire (112) gets shortened, and through relays the contact sensing unit (154) turns off the power supply (142) and turns on the motor (124). The wire (112) again starts moving downwards and comes in contact with the plate (140). The contact sensing unit (154) again plays its role in turning off the motor (124) and turning on the power supply (142) resulting in next electro-explosion. This process thereby continues till a desired concentration of nanoparticles and nanocomposites is produced in the medium. The medium (138) which now carries the nanoparticles and nanocomposites in the form of a suspension is dried in inert atmosphere and the recovered nanoparticles and nanocomposites are collected in a powder form.

FIG. 3 illustrates a contact sensing unit (154) that controls the operation of the apparatus (100) in accordance with an embodiment of this invention. The details of the contact sensing unit (154) are as follows:

i. When the wire (112) touches the plate (140) and a sufficient contact is established, the circuit comprising power supply (302), terminal Nc of main relay R₁, the power supply (142), the metal/graphite plate (140), r₂ and r₁ gets completed.
ii. A voltmeter (V) is connected across r₁ and r₂ to sense the required voltage at the non-inverting terminal (Y) of the Operational Amplifier (Op-Amp).
iii. r₂ is a variable resistance having a range of 0-60 ohm. If the resistance r₂ is equal to 0 and resistance r₁ is 5 ohms, the maximum resistance of the metal-plate contact (140) should be less than 20 ohm to give a voltage of more than 1 volt at the non-inverting terminal of Op-Amp.
iv. The Op-Amp comparator is given a stable reference of 1 volt through the zener diode of 2.5 volts that is connected in parallel to the variable resistance r₄. The Op-Amp is powered by the +/−5V DC power supply. The resistance r₄ is varied in such a way that the reference voltage at the inverting terminal of the Op-Amp can be set to 1 volt.
v. Transistor Ti (NPN) is connected at the output of the Op-Amp. T₁ changes the ON/OFF positions of relays R₂ and R₃ When OPAMP is high, base of T₁ gets a positive bias and is turned ON, current flows through the 12V battery (306) which is connected to the coils of R₂ and R₃. Both the commons get connected to N₀ and the motor (124) which is connected to N_{c} of R₃ gets disconnected.
vi. When T₁ gets appropriate bias from the OP-Amp, current from the 12V battery (306) flows through R₂ and R₃, and the common terminal of relay R₂ and R₃ changes its position to N₀. The terminal N₀ of relay R₂ is connected to a 12V voltage supply (304), which energizes the coil of R₁ and common gets connected to N₀.
vii. Terminal N_{c} of main relay R₁ is connected to the small power supply (302) and terminal N₀ of main relay R₁ is connected to the high wattage power supply (142). The output voltage of power supply (142) can be varied from 0 to 50V.
viii. The wire (112) and the plate (140) are also connected to a 5V power supply (302), through resistors r₁, r₂ & r₃ via N_{c} and common of R₁. This 5V is divided among r₁, r₂ & r₃ and the values of these resistors are kept such that the voltage across r₁ & r₂ is more than 1V to set the OP AMP to ‘High”.
ix. When current flows through main relay R₁, the common terminal of main relay R₁ changes its position to N₀.
x. The first terminal (144) and the second terminal (146) are the power outputs of the power supply (142).
xi. The first terminal (144) is a negative terminal and a first connecting wire (150) connects the first terminal (144) with the wire (112) (not labeled in FIG. 3 for the sake of brevity).
xii. A second electrical wire (148) connects the second terminal with the plate (140).

The circuit operates as follows:

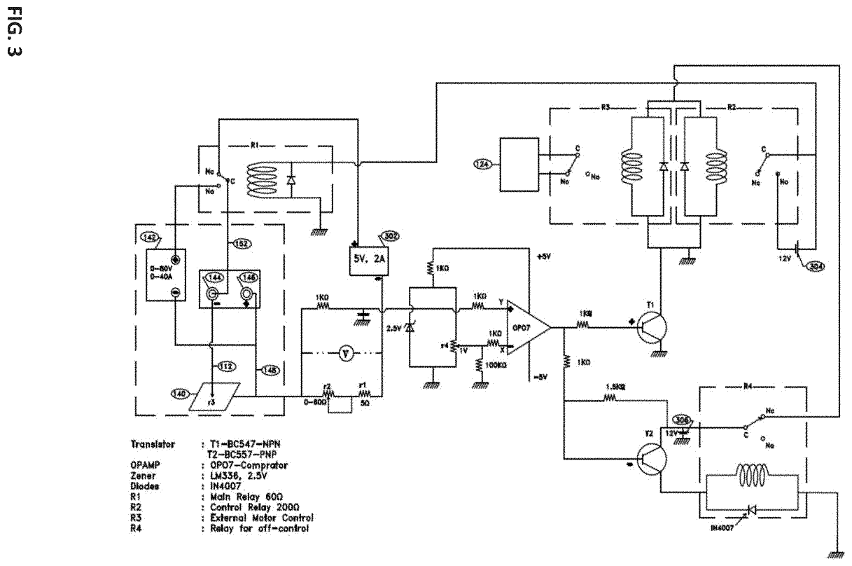

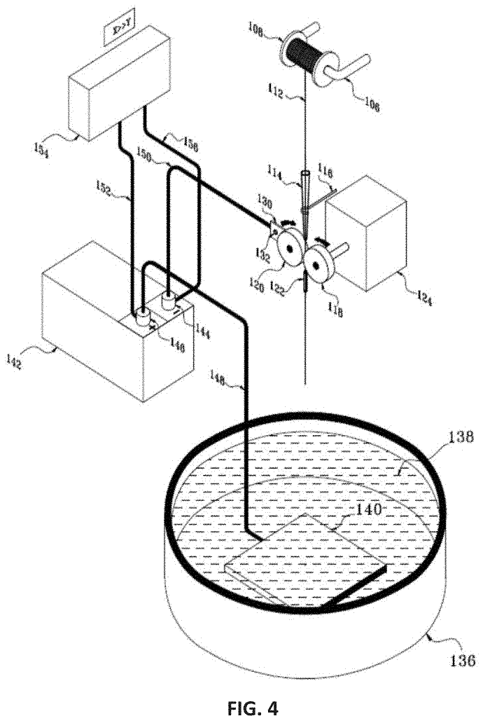

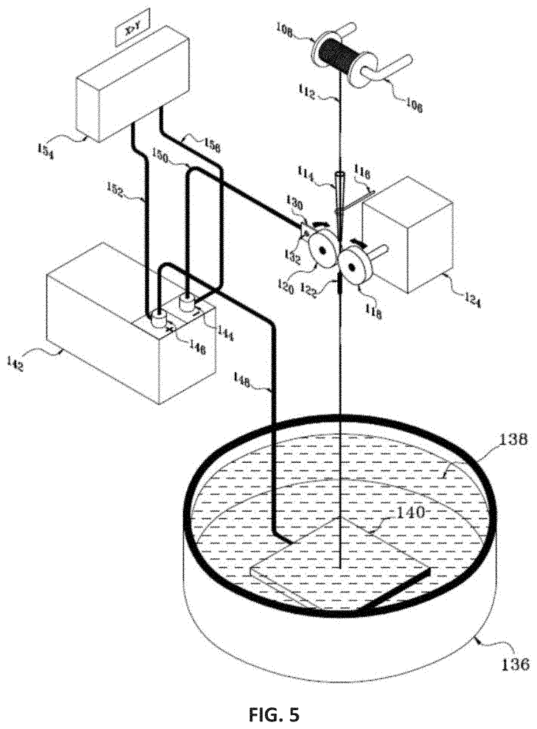

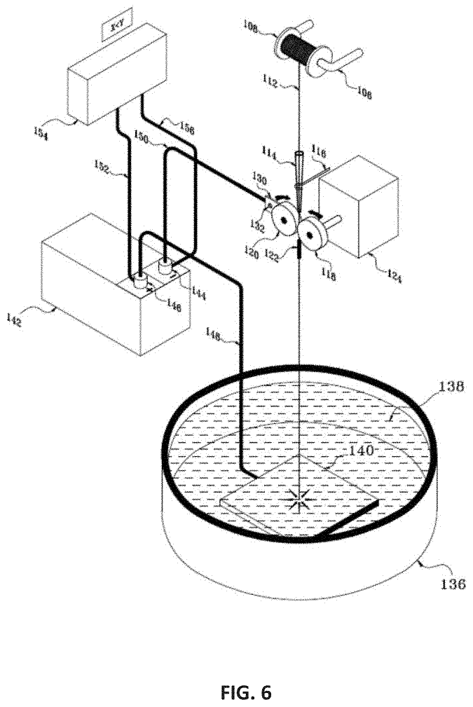

i. Initially the motor (124) is ON and the wire (112) is moving downwards towards the plate (140). The wire (112) is not in contact with the metal plate (140). In this state, the resistance r₃ would be infinite and the circuit comprising the power supply (302), the terminal N_{c} of the main relay R₁, the first terminal (144) of the power supply (142), the plate (140), the resistances r₂ and r₁ is open. The motor (124) will therefore keep feeding the wire (112) in the downward direction towards the plate (140), This state is illustrated in FIG. 4.
ii. The motor (124), which is still in ON state, keeps feeding the wire (112) downwards. The wire (112) and the plate (140) come in contact but a sufficient contact has not yet been established. In this state, the resistance r₃ would be high, that is, greater than 20 ohm, in this embodiment of the invention. Current starts flowing in the circuit comprising the power supply (302), the terminal N, of the main relay R₁, the first terminal (146), the metal plate (140), the resistances r₂ and r₁. In this state, the voltage sensed by the voltmeter (V) is less than 1 volt, as the resistance r₃ is greater than 20 ohm, The voltage sensed by the voltmeter (V) is the input for the non-inverting terminal of the Op-Amp, The output of the Op-Amp in this state will be a low because the input voltage at the non-inverting terminal of the Op-Amp is less than the reference voltage of 1V. In the low state, the transistor T₁ (NPN) remains in OFF state. No current flows through the coils of the relays R₂ and R₃ and the motor (124) remains in the ON state thereby feeding the wire (112) further downwards towards the metal plate (140). This state is illustrated in FIG. 5.
iii. The motor (124), which is still in the ON state, keeps feeding the wire (112) downwards and a sufficient contact gets established between the metal wire (112) and the plate (140). In this state, the resistance r₃ would be very low, that is, less than 20 ohm, in this embodiment of the invention. As r₃ is very low, the voltage drop across r₁ and r₂ would be greater than 1 volt, which will be measured by the voltmeter (V). This voltage sensed by the Voltmeter (V) is fed to the non inverting terminal of the Op-Amp. As the input at the non-inverting terminal of the Op-Amp is greater than the reference voltage, which is 1V, the output of the Op-Amp in this state will be high, which will turn the transistor T₁ (NPN) ON and the circuit comprising the 12V battery (304) (not labeled for the sake of brevity), the terminal N_{c} of relay R₄, relays R₂ & R₃ and transistor T₁ gets completed and current starts flowing through this circuit. As the current flows through the coils of relays R₂ & R₃, their common terminals will get connected to N₀ due to which the motor (124) gets turned OFF. Simultaneously, the battery (304) gets connected to terminal N₀ of relay R₂. Current starts flowing through the relay R₁ due to the 12V battery (304) and the common terminal of relay Ri changes its position from N₁ to N₀. The output of power supply (142) is taken across the first terminal (144) and the second terminal (146). The first terminal (144) gets connected to the plate (140) when the metal wire (112) touches the plate (140). The second terminal (146) is connected to the metal plate (140) through the connecting wire (148). Once a proper contact is established between the wire and the plate (140), the voltage applied causes electro-explosion. This state is illustrated in FIG. 6.
iv. Due to the explosion, the length of the metal wire (112) gets shortened and nanoparticles are formed and get suspended in the medium (138). As a result, the resistance r₃ again becomes infinite. The circuit comprising the power supply (302), the terminal N_{c} of the main relay R₁, the first terminal (144) of the power supply (142), the metal plate (140), the resistances r₂ and r₁ becomes open. In this state, the voltage sensed by the voltmeter (V) becomes 0 Volt, that is, less than 1 volt, resulting in a negative output or low state of the Op-Amp. The transistor Ti (NPN) will be turned OFF. The negative output of the Op-Amp will turn ON the transistor T₂ (PNP) due to which current starts flowing through the coil of relay R₄. The common terminal of relay R₄ gets connected to N₀ from N₁ due to which the voltage source (306) gets disconnected from the relays R₂ and R₃. As there is no flow of current in the coils of R₂ and R₃, the common terminal of relay R₃ and R₂ gets connected to N₁ from N₀, due to which the voltage source (306) gets disconnected from the relay R₁. The common terminal of relay R₁, gets connected to terminal N₁ of relay R₁ due to which the circuit comprising the power supply (302), the terminal N_{c} of the main relay R₁, the first terminal (144) of the power supply (142), the plate (140), the resistances r₂ and r₁ becomes open and the wire (112) loses contact with the plate (140). At the same time the common terminal of relay R₃ gets connected to terminal N_{c}, the motor (124) gets turned. ON and again starts pushing the wire downwards. This state is illustrated in FIG. 3.
v. The time gap (T) between two successive explosions may be controlled by varying the speed (X) of the first roller (118) and the second roller (120) by controlling the speed of the motor (124).

In this embodiment of the invention, the resulting nanoparticles have an average size of 2-50 nm and in case of Graphene nanocomposite, they are anchored on Graphene sheets which are even larger than 500 nms. Using this invention, a wide variety of metal-metal and metal-Graphene composites adaptable to different applications can be made, by simply changing the specifications of metals which defines the ratio of nanoparticles in metal Graphene nanocomposite. This invention is also used for making metal-metal nanocomposite and also to add surfactant in metal nanoparticles and nanocomposites. Accordingly, the specification and drawings are to be regarded as illustrative rather than in a restrictive sense.

Preferably, the predetermined range of values of the variable resistance (r₂) ranges from 0 to 60 ohms and the plate (140) is made up of a metal or graphite. The predetermined speed (X) of the first roller (118) and the second roller (120) is such that 0.5-3 cms of wire is fed per minute and the predetermined interval (T) of explosion is at least 1 seconds. The first terminal (144) of the power supply is a negative terminal and the second terminal (146) of the power supply is a positive terminal. Typically, the second wire guide (122) is made of glass. Typically, a voltage in the range of 25V to 50V and current in a range of 40 Amp to 50 Amp is applied between the first terminal (144) and the second terminal (146). The medium (138) is selected from amongst double distilled water, organic solvents like ethane, isobutene, acetylene, butanol etc. and heavy oils.

The process is very energy intensive since only relatively low voltages are applied, and also results in high volumes of nanocomposite being produced since both electrodes are consumed. In an embodiment of the present invention the diameter of wires employed are in the range of 0.1 mm-0.35 mm to carry current in the range of 0.96×10⁶ A/m²−77.6×10⁵ A/m² to obtain the desired size of nanoparticles after explosion. For metal Graphene nanocomposites, locally available pure graphite plate (140) as well as HOPG sheet from Alfa Aesar can be used. For metal metal nanocomposites, high purity metal wires and plates (99.99%) were utilised. The nanoparticles/nanocomposites thus prepared have an average size of 2-50 nm.

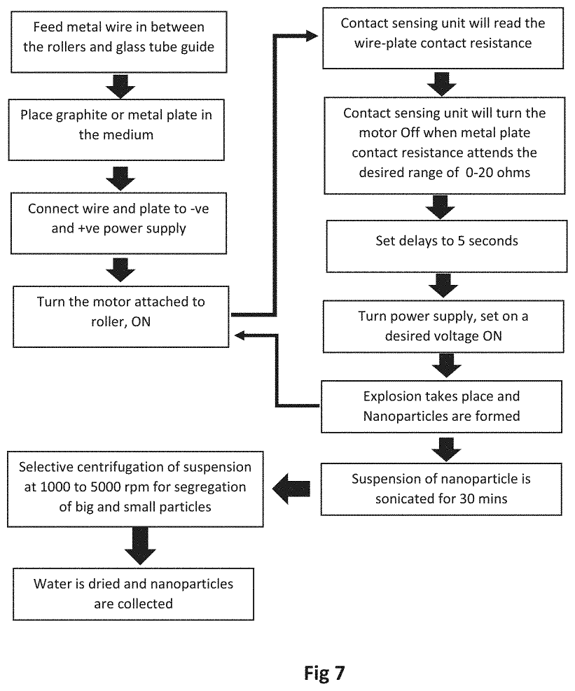

FIG. 7 illustrates flow chart of the method used for the production of nanoparticles and nanocomposites. Metal wire (112) to be exploded is fed between the first roller (118) and the second roller (120) kept in close contact with each other and made to pass through the second wire guide (122) so that it hits the plate (140) kept in the medium. Plate (140) can be made of either metal or graphite. The metal wire (112) and the plate (140) are connected to the negative terminal (144) and positive terminal (146) of a power supply (142) which is set at a desired current and voltage so as to produce electro-explosion when the metal wire (112) makes a good contact with the plate (140). A contact sensing unit (154) is also connected to the metal wire and plate, which reads the contact resistance (r₃) between the metal wire and plate and stops the motor (124) from further driving the metal wire (112) towards the plate (140) when the contact resistance r₃ attains the desired range of values. Once a good contact is established, and motor (124) is turned off, power supply (142) is turned ON after a small delay and electro-explosion takes place resulting in the formation of nanoparticles or nanocornposites. These particles are first sonicated in the medium to remove aggregation and then segregated through selective centrifugation. After segregation the particles are dried in an inert environment and stored. If the metal wire and the plate are of the same metal, pure nanoparticles are formed. If the plate is of a different metal, then metal-metal nanocomposites are formed and when the plate is of graphite, then metal-graphene nanocomposites are formed.

In an embodiment of the invention, the plate (140) is made up of a material selected but not limited to a pure metal, graphite, or a metal alloy. The metal is selected from the group of gold, silver, platinum, palladium, cobalt, manganese, iron, tellurium, rhodium, ruthenium, copper, iridium, molybdenum, chromium, cerium and alike. The medium in which the plate is kept comprises of double distilled water, organic solvents like ethane, isobutene, acetylene, butanol etc., heavy oils, or an optional capping agent known in the art to make nanoparticles of metal: oxides, nitrides, carbides, sulphides etc. The metal wire is made of metal selected from the group of gold, silver, platinum, palladium, cobalt, manganese, iron, tellurium, rhodium, ruthenium, copper, iridium, molybdenum, chromium, cerium and alike.

The nanocomposites thus prepared include but are not limited to a composite with graphene or a metal-metal nanocomposite with a combination of gold, silver, ⁻platinum, palladium, cobalt, manganese, iron, tellurium, rhodium, ruthenium, copper, iridium, molybdenum, chromium, cerium.

In an embodiment of the present invention, this method has also been used to make metal nanoparticles of gold, silver, platinum, iron, copper, aluminium etc. where the wire (112) and the plate (140) were of the same material.

The following embodiments are given by way of illustration of the method of the present invention and therefore should not be construed to limit the scope thereof.

In another embodiment of the invention, referring to FIGS. 1-6, and FIGS. 8A-8F, the apparatus (100) as explained hereinbefore is utilized for preparation of copper nanoparticles and copper nanocomposites. In this embodiment, a glass vessel is used as a container (136) and the metal wire (112) is made of copper. The container (136) reactor vessel is filled up with a suitable dense medium so as to completely immerse the plate (140), which may be of metal or graphite, and 3-4 mm of the metal wire (112).

The exploded metal particles remain suspended in the medium (138) which is collected in the following manner. An initial centrifuge of the suspension at 1000 RPM separates the fluid from the large particles. While the former is rejected, the solid mass is dispersed in water again and sonicated. It is again centrifuged at 4000 RPM and the solid mass is collected and dried on a heater for further analysis.

Part of the solid mass was incorporated in a paper matrix, dried and held firm for x-ray diffraction studies (XRD). First, for reference, an XRD pattern was generated for bulk copper as a θ-2θ plot scanning from 41-100° generating the lines (111), (200), (220), (311), (222) at 2θ=43.44°, 50.50°, 74.20°, 90.00°, and 95.10° respectively. For nano-copper sample collected and incorporated in the said paper matrix, main peaks at 2θ=43.44°, 50.50°, 74.20°, 90.00°, was observed. This indicates the purity of the nanoparticle as far as the (111), (200), (220), (311) lines are concerned. This further indicates reorientation of the nanoparticle grains preferentially in one direction as against the random orientation of grains in the bulk material.

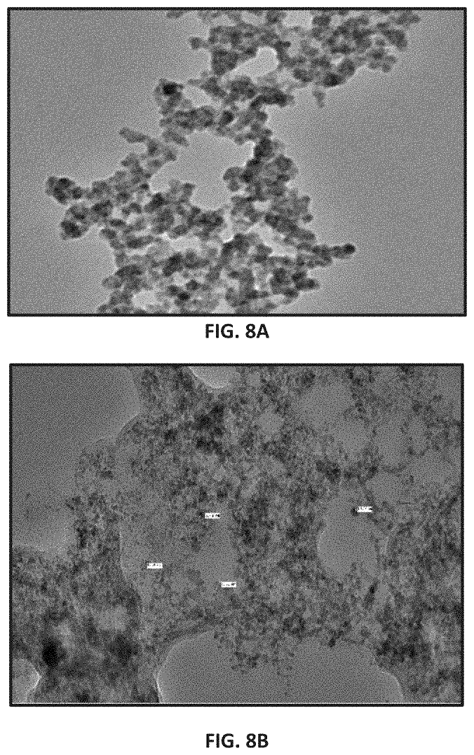

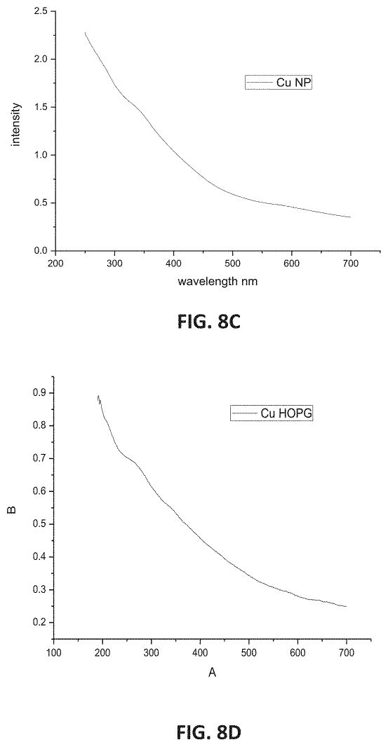

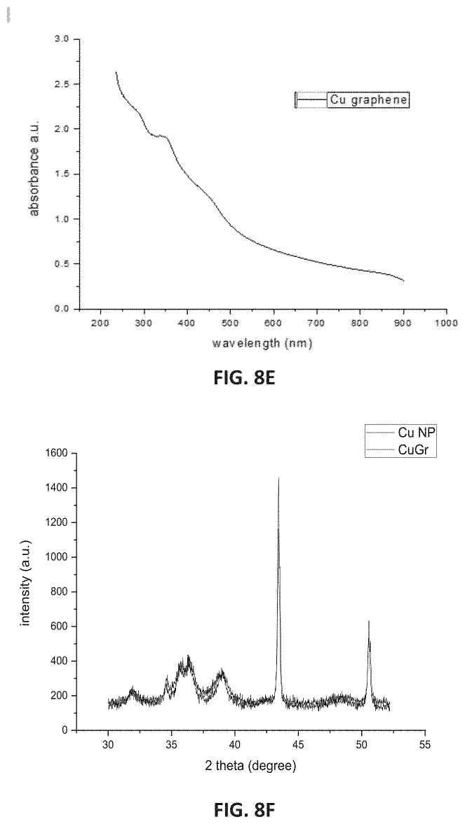

FIG. 8A and 8B shows TEM image of copper nanoparticle and copper graphene nanocomposite respectively, at the specified magnification wherein particle size is 2-50 nms. FIG. 8C is UV vis absorption spectra of pure copper nanoparticle with a characteristic absorption peak at ˜350 nm. In TEM image of Copper graphene nanocomposite at the specified magnification, Copper nanoparticles of size 2-50 nms are embedded over a graphene sheet of more than 500 nm. FIG. 8D depicts UV vis absorption spectra of copper graphene nanocomposite (through explosion of Copper on HOPG) with a characteristic absorption peak for copper around 350, and an additional peak at 265 nm which is the characteristic absorption peak for graphene, confirms the conjugation. UV vis absorption spectra of copper graphene nanocomposite (through explosion of Copper on Graphite) is shown in FIGS. 8D and 8E, with a characteristic absorption peak for copper around 350, and an additional peak at 265 nm which is the characteristic absorption peak for graphene, confirms the conjugation. FIG. 8F shows X-ray diffraction (XRD) pattern of copper and Copper Graphene, which almost matches with the bulk material suggesting that the crystallinity of structure is maintained in the pure nanoparticle as well as in the composite.

in yet another embodiment of the invention, referring to FIGS. 1-6, and FIGS. 9A-9F, the apparatus (100) as explained hereinbefore is utilized for preparation of silver nanoparticles and silver nanocomposites. In this embodiment, a glass vessel is used as a container (136) and the metal wire (112) is made of silver. The container (136) reactor vessel is filled up with a suitable dense medium so as to completely immerse the plate (140), which may be of metal or graphite, and 3-4 mm of the metal wire (112). The process of selective centrifugation of suspension at 1000 and 4000 rpm as explained above is utilized in order to separate big and small particles.

Part of the solid mass was incorporated in a paper matrix, dried and held firm for x-ray diffraction studies (XRD). First for reference an XRD pattern was generated for bulk silver as a θ-2θ plot scanning from 38°-100° generating the lines (111), (200), (220), (311), (222) at 2θ=38.144°, 44.273°, 64,470°, 77.379°, and 81.500° respectively. For the nano-silver sample held onto a paper matrix as stated above, an XRD pattern was generated as a θ-2θ plot scanning from 38°-100° generating the lines (111), (200), (220), (311), (222) at 2θ=38.016°, 44.182°, 64.351°, 77.317°, and 81.500° respectively. The position of these lines in XRD is similar to those obtained in bulk silver and only slightly shifted in case of nanocomposites preserving the peaks. This indicate the purity of the nanoparticle lattice having bulk-like periodicity in the particles investigated.

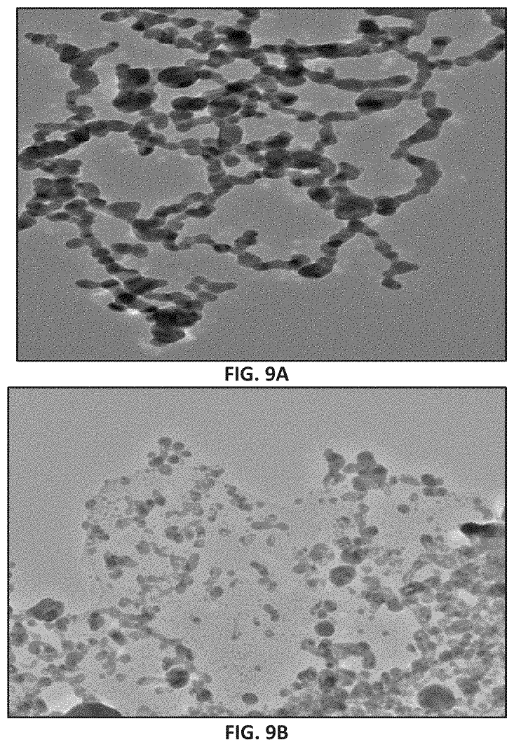

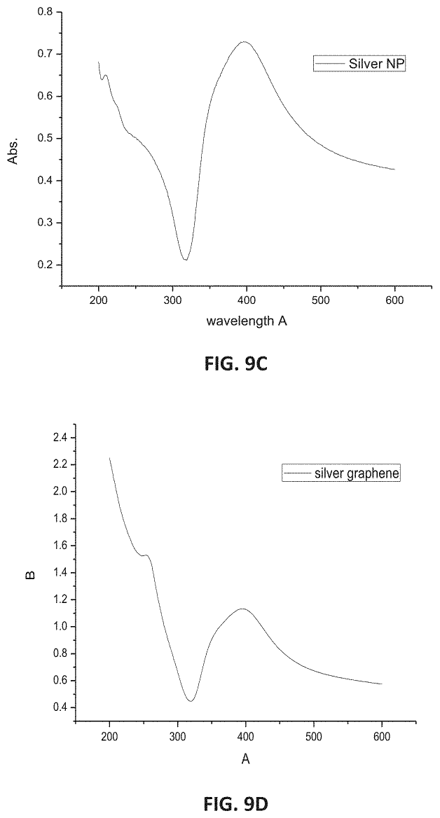

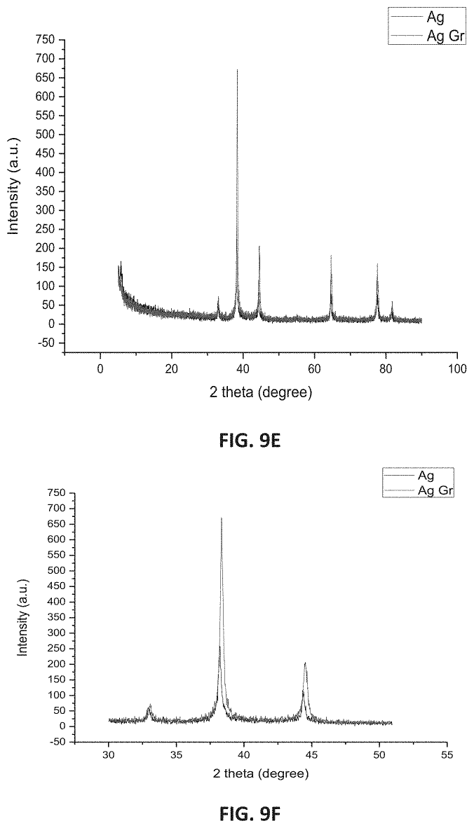

FIGS. 9A and 9B show the TEM image of Silver nanoparticle and silver graphene nanocomposites at the specified magnification with particle size is 2-50 nms. FIG. 9C is UV vis absorption spectra of pure silver nanoparticle with a characteristic absorption peak at 410 nm. TEM image of Silver graphene nanocomposite at the specified. magnification having silver nanoparticle size of 2-50 nms embedded over a graphene sheet of more than 500 nm. FIG. 9D is a UV vis absorption spectra of silver graphene nanocomposite with a characteristic absorption peak for silver around 400, slightly red shifted as surface states change because of conjugation. An additional peak at 265 nm which is the characteristic absorption peak for graphene confirms the conjugation.

FIGS. 9E and 9F depict an X-ray diffraction (XRD) pattern of Silver and Silver Graphene, which almost match with the bulk material suggesting that the crystallinity of structure is maintained even at nanoscale. A magnified view of the XRD of Silver and

Silver Graphene can be seen in FIG. 9F. Graphene coated Silver shows higher intensity and marginal shift in the peak positions because of conjugation.

yet another embodiment of the invention, referring to FIGS. 1-6, and FIGS. 10A-10F, the apparatus (100) as explained hereinbefore is utilized for preparation of iron nanoparticles and iron nanocomposites. In this embodiment, a glass vessel is used as a container (136) and the metal wire (112) is made of iron. The container (136) reactor vessel is filled up with a suitable dense medium so as to completely immerse the plate (140), which may be of metal or graphite, and 3-4 mm of the metal wire (112). The process of selective centrifugation of suspension at 1000 and 4000 rpm as explained above is utilized in order to separate big and small particles.

Part of the solid mass was incorporated in a paper matrix, dried and held firm for x-ray diffraction studies (XRD). First for reference an XRD pattern was generated for bulk iron as a Q-2Q plot scanning from 10-100° generating the lines (110), (200), (211) at 2Q=44.8°, 65.0° and 82.0° respectively. For the nano-iron graphene sample held onto the paper matrix as stated above, an XRD pattern was generated as a Q-2Q plot scanning from 10°-100° generating the line (110), at 2Q=44.8° while other peaks were missing. This may be due to reorientation of the nanoparticle grains preferentially in one direction as against the random orientation of grains in the bulk material. The position of this lines in XRD is similar to those obtained in bulk iron. This indicates the purity of the nanoparticle lattice having bulk-like periodicity in the particles investigated.

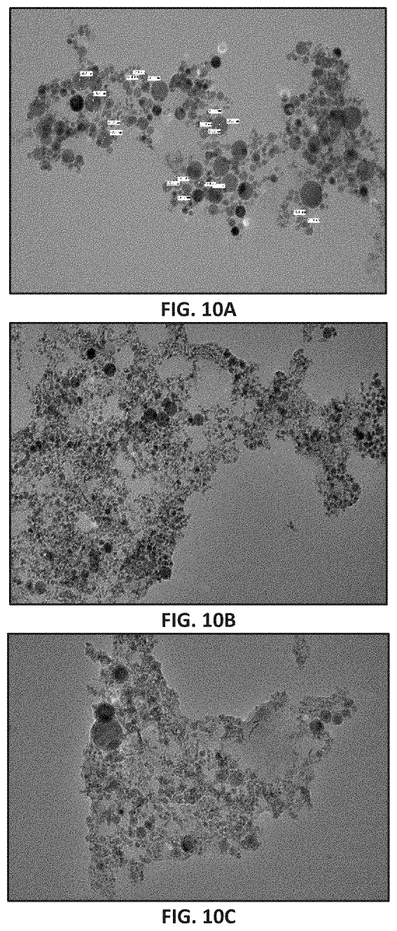

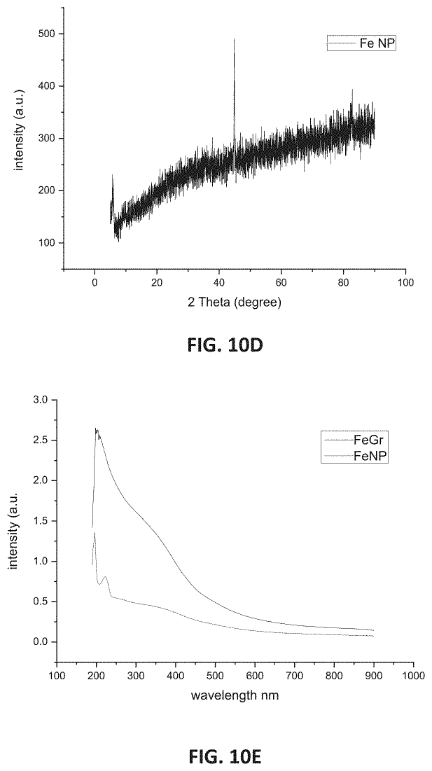

FIG. 10A shows TEM image of Iron nanoparticle at the specified magnification where particle size is 2-40 nms. TEM image of Iron graphene nanocomposite at the specified magnification is shown in FIGS. 10B and 10C. Particle size is 2-40 nms embedded over a graphene sheet of more than 500 nm. Particle size is 2-40 nms embedded over a graphene sheet of more than 500 nm. X-ray diffraction (XRD) pattern of Iron Graphene is seen in FIG. 10D, which almost match with the bulk material suggesting that the crystallinity of structure is maintained even in composites at nanoscale. FIG. 10E is UV-vis absorption spectra of iron nanoparticle with a characteristic absorption peak at ˜240 nm and 375 nm. Whereas, Iron Graphene nanocomposite shows higher absorption but the peaks are not distinct and can be seen as humps around 350-375 nms.

In yet another embodiment of the invention, referring to FIGS. 1-6, and FIGS. 11A-11D, the apparatus (100) as explained herein before is utilized for preparation of gold nanoparticles and gold nanocomposites. In this embodiment, a glass vessel is used as a container (136) and the metal wire (112) is made of gold. The container (136) reactor vessel is filled up with a suitable dense medium so as to completely immerse the plate (140), which may be of metal or graphite, and 3-4 mm of the metal wire (112). The process of selective centrifugation of suspension at 1000 and 4000 rpm as explained. above is utilized in order to separate big and small particles.

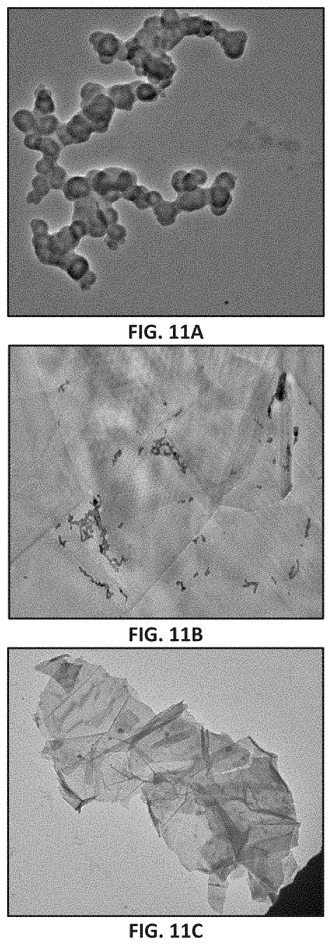

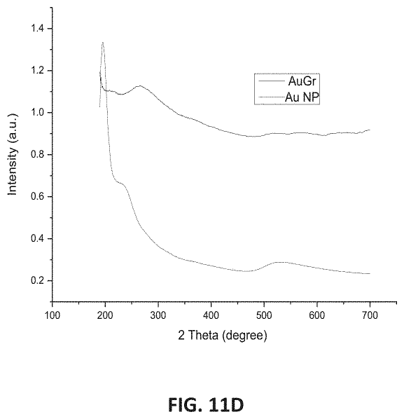

FIG. 11A is TEM image of Gold nanoparticle at the specified magnification. Particle size is 2-50 nms. FIG. 11B is TEM image of Gold graphene nanocomposite at the specified magnification. Particle size is 2-50 nms embedded on graphene sheet larger than one micron. Hexagonal structure of carbon atoms in graphene is also visible suggesting that the sheet is one, two or few layered. FIG. 11C is another TEM image of pristine graphene sheet with few gold NP on it.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and

should not be regarded as limiting.

I claim:

1. An apparatus (100) for production of nanoparticles or nanocomposites comprising:
a metal wire (112) operably connected to a motor (124); said metal wire (112) passing through a first wire guide (114);
at least two rollers (118, 120), at least one roller amongst said at least two rollers (118, 120) being metallic, at least one roller amongst said at least two rollers (118, 120) being connected to said motor (124), said at least two rollers (118, 120) being in contact and rolling at a predetermined speed (X), said metal wire (112) after passing through said first wire guide (114) passing between said at least two rollers (118, 120);
said at least two rollers (118, 120) guiding said metal wire (112) through a second wire guide (122) onto said plate (140), said second wire guide (122) being an insulator;
said plate (140) being placed inside a medium (138);
a container (136) enclosing said plate (140) and said medium (138);
a power supply (142), wherein a first terminal (144) of said power supply (142) is electrically in contact with said metal wire (112) and a second terminal (146) of said power supply (142) is electrically in contact with said plate (140);
a contact sensing unit (154) operably connected to said at least two rollers (118, 120), said metal wire (112), said plate (140), said motor (124) and said power supply (142), said motor (124) intermittently rolling at least one roller amongst said at least two rollers (118, 120) rolling at said predetermined speed (X) bringing said metal wire (112) in contact with said plate (140);
wherein, intermittent controlled electro-explosions take place at a predetermined interval (T) as said metal wire (112) comes in contact with said plate (140).

2. An apparatus (100) for production of nanoparticles or nanocomposites as claimed in claim 1, wherein said at least two rollers (118, 120) are a first roller (118) and a second roller (120).

3. An apparatus (100) for production of nanoparticles or nanocomposites as claimed in claim 1, wherein said contact sensing unit (154) turns OFF said motor (124) as a contact resistance (r₃) between said metal wire (112) and said plate (140) reaches between 0 to 20 ohms.

4. An apparatus (100) for production of nanoparticles or nanocomposites as claimed in claim 3, wherein said contact sensing unit (154) turns ON said power supply (142) after said motor (124) is turned OFF resulting in an electro-explosion.

5. An apparatus (100) for production of nanoparticles or nanocomposites as claimed in claim 4, wherein said contact sensing unit (154) turns OFF said power supply (142) and turns ON said motor (124) after said electro-explosion has occurred.

6. An apparatus (100) for production of nanoparticles or nanocomposites as claimed in claim 1, wherein said plate (140) is made up of a metal or graphite.

7. An apparatus (100) for production of nanoparticles or nanocomposites as claimed in claim 2, wherein said predetermined speed (X) of said first roller (118) and said second roller (120) is such that it feeds 0.5-3 cms metal wire (112) per minute.

8. An apparatus (100) for production of nanoparticles or nanocomposites as claimed in claim 1, wherein said predetermined interval (T) is at least 1 second.

9. An apparatus (100) for production of nanoparticles or nanocomposites as claimed in claim 1, wherein said first terminal (144) of said power supply is a negative terminal and said second terminal (146) of said power supply is a positive terminal.

10. An apparatus (100) for production of nanoparticles or nanocomposites as claimed in claim 1, wherein said second wire guide (122) is made of glass.

11. An apparatus (100) for production of nanoparticles or nanocomposites as claimed in claim 1, wherein a voltage in a range of 25V to 50V and current in a range of 40 Amp to 50 Amp is applied between said first terminal (144) and said second terminal (146).

12. An apparatus (100) for production of nanoparticles or nanocomposites as claimed in claim 1, wherein said medium (138) is selected from amongst double distilled water, organic solvents like ethane, isobutene, acetylene, butanol and heavy oils.

13. A method for production of nanoparticles or nanocomposites comprising the steps of:
operably connecting a motor (124) to a metal wire (112
passing said metal Tire (112) through a first wire guide (114);
connecting at least one roller amongst at least two rollers (118, 120) to said motor (124), at least one roller amongst said at least two rollers (118, 120) being metallic, said at least two rollers (118, 120) being in contact and rolling at a predetermined speed (X), said metal wire (112) after passing through said first wire guide (114) passing between said at least two rollers (118, 120);
said at least two rollers (118, 120) guiding said metal wire (112) through a second wire guide (122) onto a plate (140), said second wire guide (122) being an insulator;
placing said plate (140) inside a medium (138);
enclosing said plate (140) and said medium (138) in a container (136); electrically connecting a first terminal (144) of a power supply (142) to said metal wire (112) and a second terminal (146) of said power supply (142) to said plate (140);
operably connecting a contact sensing unit (154) to at least one roller among said at least two rollers (118, 120), said metal wire (112), said plate (140), said motor (124) and said power supply (142), said motor (124) intermittently rolling at least one roller amongst said at least two rollers (118, 120) at said predetermined speed (X) bringing said metal wire (112) in contact with said plate (140);
wherein, intermittent controlled electro-explosions take place at a predetermined interval (T) as said metal wire (112) comes in contact with said plate (140),

14. A method for production of nanoparticles or nanocomposites as claimed in claim 13, wherein said at least two rollers (118, 120) are a first roller (118) and a second roller (120).

15. A method for production of nanoparticles or nanocomposites as claimed in claim 13, wherein said contact sensing unit (154) turning OFF said motor (124) as a contact resistance (r₃) between said metal wire (112) and said plate (140) reaches between 0 to 20 ohms.

16. A method for production of nanoparticles or nanocomposites as claimed in claim 15, wherein said contact sensing unit (154) turning ON said power supply (142) after said motor (124) is turned OFF resulting in an electro-explosion.

17. A method for production of nanoparticles or nanocomposites as claimed in claim 15, wherein said contact sensing unit (154) turns OFF said power supply (142) and turns ON said motor (124) after said electro-explosion has occurred.

18. A method for production of nanoparticles or nanocomposites as claimed in claim 13, wherein said plate (140) is made up of a metal or graphite.

19. A method for production of nanoparticles or nanocomposites as claimed in claim 14, wherein said predetermined speed (X) of said first roller (118) and said second roller (120) is such that it feeds 0.5-3 cms metal wire (112) per minute.

20. A method for production of nanoparticles or nanocomposites as claimed in claim 13, wherein, said predetermined interval (T) is at least 1 second.

21. A method for production of nanoparticles or nanocomposites as claimed in claim 13, wherein said first terminal (144) of said power supply is a negative terminal and said second terminal (146) of said power supply is a positive terminal.

22. A method for production of nanoparticles or nanocomposites as claimed in claim 13, wherein said second wire guide (122) is made of glass.

23. A method for production of nanoparticles or nanocomposites as claimed in claim 13, wherein applying a voltage in a range of 25V to 50V and current in a range of 40 Amp to 50 Amp between said first terminal (144) and said second terminal (146).

24. A method for production of nanoparticles or nanocomposites as claimed in claim 13, wherein selecting said medium (138) from amongst double distilled water, organic solvents like ethane, isobutene, acetylene, butanol and heavy oils.
